(19) United States
(12) Patent Application Publication
(10) Pub. No.: US 2021/0223614 A1
(43) Pub. Date: Jul. 22, 2021

(54) DISPLAY DEVICE

(71) Applicant: Samsung Display Co., Ltd., Yongin-Si (KR)

(72) Inventors: Kon-Haeng LEE, Anyang-si (KR); In-Ho PARK, Asan-si (KR); Kook Hyun CHOI, Asan-si (KR)

(21) Appl. No.: 17/014,956

(22) Filed: Sep. 8, 2020

(30) Foreign Application Priority Data
Jan. 20, 2020 (KR) 10-2020-0007255

(51) Int. Cl. G02F 1/1335

(52) U.S. Cl. CPC G02F 1/133512; G02F 1/136286

(57) ABSTRACT

A display device includes: a display area including a plurality of pixel portions, a plurality of gate lines extending in a first direction, and a plurality of data lines extending in a second direction crossing the first direction, wherein the display area is divided into a first display area and a second display area by a first boundary that extends in the second direction; and a plurality of light blocking portions extending in the first direction between adjacent ones of the plurality of pixel portions that are arranged in the second direction to overlap the plurality of gate lines and blocking light between the adjacent ones of the plurality of pixel portions, wherein a width of a light blocking portion decreases from an edge of the display area toward the first boundary.

### CROSS-REFERENCE TO RELATED APPLICATION

This application claims priority to and the benefit of Korean Patent Application No. 10-2020-0007255 filed in the Korean Intellectual Property Office on Jan. 20, 2020, the disclosure of which is incorporated herein by reference in its entirety.

### BACKGROUND

### (a) Field

The present disclosure relates to a display device. More particularly, embodiments of the present disclosure relates to a display device that is capable of preventing unevenness due to a light blocking portion.

### (b) Description of the Related Art

A liquid crystal display is one of the most common types of display devices. The liquid crystal display includes a display panel on which an electrode and a liquid crystal layer are formed, and the display panel rearranges liquid crystal molecules of the liquid crystal layer by applying a voltage to the electrode to form an electric field, and displays an image by controlling transmittance of light through the liquid crystal layer.

Each of a plurality of pixels included in the liquid crystal display includes a pixel electrode, a common electrode, and a switching transistor connected to the pixel electrode. The switching transistor is connected to a gate line that transmits a gate signal generated by a gate driver and to a data line that transmits a data voltage generated by a data driver, and transmits the data voltage to the pixel electrode according to the gate signal.

The display panel may include a light blocking portion for preventing light leakage between adjacent pixel electrodes. The light blocking portion is commonly referred to as a black matrix. The light blocking portion may block external light from entering the gate line and the switching transistor, thereby improving a contrast of an image being displayed. The light blocking portion defines a pixel portion where the pixel electrode is disposed. The image may be displayed by the light emitted from a backlight passing through the plurality of pixel portions.

For a large-sized display panel, a mask having a size smaller than the display panel may be used for forming the light blocking portion. In this case, two or more exposure processes may be required to form the light blocking portion on the entire display panel. For example, a first exposure process may be performed on a left region of the display panel using the mask, and a second exposure process may be performed on a right region of the display panel.

However, due to a process error, the light blocking portion formed in the left region and the light blocking portion formed in the right region may be displaced or dislocated from a boundary between the left region and the right region of the display panel, forming the light blocking portion in an inaccurate position. This may cause a difference of the size of the pixel portion through which light is transmitted in the left and right regions of the display panel, and vertical stripes may be recognizable at the boundary between the left region and the right region when displaying an image.

The above information disclosed in this Background section is for enhancement of understanding of the background of the present disclosure, and it may contain information that does not form a prior art that is already known to a person of ordinary skill in the art.

### SUMMARY

Embodiments of the present disclosure provide a display device capable of preventing a stain that may be recognizable due to a light blocking portion.

A display device according to an exemplary embodiment of the present disclosure includes: a display area including a plurality of pixel portions, a plurality of gate lines extending in a first direction, and a plurality of data lines extending in a second direction crossing the first direction, wherein the display area is divided into a first display area and a second display area by a first boundary that extends in the second direction; and a plurality of light blocking portions extending in the first direction between adjacent ones of the plurality of pixel portions that are arranged in the second direction to overlap the plurality of gate lines and blocking light between the adjacent one of the plurality of pixel portions, wherein a width of the light blocking portion among the plurality of light blocking portions decreases from an edge of the display area toward the first boundary.

The light blocking portion may have a first width at a first edge of the first display area and a second edge of the second display area, and may have a second width that is smaller than the first width at the first boundary.

The width of the light blocking portion may be largest at the edge of the display area and smallest at the first boundary.

The light blocking portion may be dislocated at the first boundary in the second direction by equal to or less than an error margin.

The light blocking portion may have a first width at the edge of the display area and may have a second width at the first boundary, and the error margin may be equal to or smaller than half of a difference between the first width and the second width.

The width of the light blocking portion may be, in the first display area, uniform from the first edge to a first changing portion and decrease from the first changing portion toward the first boundary, and the width of the light blocking portion may be, in the second display area, uniform from the second edge to a second changing portion and decrease from the second changing portion toward the first boundary.

A first distance between the first changing portion and the first boundary may be 3 cm to 6 cm, and a second distance between the second changing portion and the first boundary may be 3 cm to 6 cm. The light blocking portion may be dislocated at the first boundary in the second direction by equal to or less than an error margin.

The display area may be further divided into the second display area and a third display area by a second boundary, and the width of the light blocking portion may decrease from the edge of the display area toward the second boundary.

The width of the light blocking portion may be uniform from a center of the second display area to a first changing portion and decrease from the first changing portion toward the first boundary, and the width of the light blocking portion may be uniform from the center of the second display area to a second changing portion and decrease from the second changing portion toward the second boundary.

A display device according to another exemplary embodiment of the present disclosure includes: a display area including a plurality of pixel portions, a plurality of gate lines extending in a first direction, and a plurality of data lines extending in a second direction crossing the first direction, wherein the display area is divided into a first display area and a second display area by a first boundary that extends in the second direction; and a plurality of light blocking portions extending in the first direction between adjacent ones of the plurality of pixel portions that are arranged in the second direction to overlap the plurality of gate lines, blocking light between the adjacent ones of the plurality of pixel portions, wherein the plurality of light blocking portions extend from a first edge of the first display area to a second edge of the second display area crossing the first boundary, and, wherein a width of a light blocking portion among the plurality of light blocking portions is largest at the first edge and the second edge and is smallest at the first boundary.

The width of the light blocking portion may decrease from the first edge toward the first boundary in the first display area and decrease from the second edge toward the first boundary in the second display area.

The light blocking portion may be dislocated at the first boundary in the second direction by equal to or less than an error margin.

The light blocking portion may have a first width at the first edge and the second edge and may have a second width at the first boundary, and the error margin may be equal to or less than half of a difference between the first width and the second width.

The width of the light blocking portion may be, in the first display area, uniform from the first edge to a first changing portion and decrease from the first changing portion toward the first boundary, and the width of the light blocking portion may be, in the second display area, uniform from the second edge to a second changing portion and decrease from the second changing portion toward the first boundary.

A first distance between the first changing portion and the first boundary may be 3 cm to 6 cm, and a second distance between the second changing portion and the first boundary may be 3 cm to 6 cm.

The light blocking portion may be dislocated at the first boundary in the second direction by equal to or less than an error margin.

The display area may be further divided into the second display area and a third display area by a second boundary, and the width of the light blocking portion may decrease from a third edge of the third display area toward the second boundary.

A second average of the width of the light blocking portion in the second display area may be different from a first average of the width of the light blocking portion in the first display area or a third average of the width of the light blocking portion in the third display area.

The width of the light blocking portion may be uniform from a center of the second display area to a first changing portion and decrease from the first changing portion toward the first boundary, and the width of the light blocking portion may be uniform from the center of the second display area to a second changing portion and decrease from the second changing portion toward the second boundary.

The plurality of light blocking portions having a varying width according to the above-described embodiments of the present disclosure may prevent a stain that may be recognizable due to the light blocking portion. Further, an inspection time may be reduced for generating stain correction data by measuring the luminance of the display device with a luminance measurement device, and it may be unnecessary to provide a memory for storing the stain correction data.

### BRIEF DESCRIPTION OF THE DRAWINGS

FIG. 1 is a block diagram schematically showing a display device according to an exemplary embodiment of the present disclosure.

FIG. 2 is a top plan view showing a light blocking portion of FIG. 1.

FIG. 3 is a top plan view showing one pixel of a display device according to an exemplary embodiment of the present disclosure.

FIG. 4 is a cross-sectional view of a display device taken along a line A-A′ of FIG. 3.

FIG. 5 is a top plan view of a case in which a light blocking portion of FIG. 2 is dislocated by an error margin at a first boundary.

FIG. 6 is a top plan view showing a light blocking portion according to an exemplary embodiment of the present disclosure.

FIG. 7 is a top plan view showing a light blocking portion according to a comparative example.

FIG. 8 is a top plan view showing a light blocking portion according to another exemplary embodiment of the present disclosure.

FIG. 9 is a top plan view showing a case that a light blocking portion of FIG. 8 is dislocated by an error margin at a first boundary.

FIG. 10 is a block diagram schematically showing a display device according to another exemplary embodiment of the present disclosure.

FIG. 11 is a top plan view showing a light blocking portion of FIG. 10 in more detail.

### DETAILED DESCRIPTION

Embodiments of the present disclosure will be described more fully hereinafter with reference to the accompanying drawings, in which exemplary embodiments of the present disclosure are shown. As those skilled in the art would realize, the exemplary embodiments may be modified in various different ways, without departing from the spirit or scope of the present disclosure.

In order to clearly explain the present disclosure, portions that are not directly related to the present disclosure may be omitted, and the same reference numerals may be user to refer to the same or similar constituent elements through the present disclosure.

Further, in the drawings, each element may be representatively shown for better understanding and ease of description, but the present disclosure is not limited thereto. For example, the thickness of layers, films, panels, regions, etc., may be exaggerated for clarity.

It will be understood that when an element such as a layer, film, region, or substrate is referred to as being “on” another element, it can be directly on the other element, or one or more intervening elements may also be present. In contrast, when an element is referred to as being “directly on” another element, there are no intervening elements present therebetween. Further, in the specification, the word “on” or “above” means positioned on (or above) or below (or beneath) the object portion, and does not necessarily mean positioned on an upper side of the object portion based on a gravitational direction.

In addition, unless explicitly described to the contrary, the word “comprise” and its variations such as “comprises” or “comprising” will be understood to imply an inclusion of stated elements but not an exclusion of any other elements.

Further, throughout the specification, the phrase “on a plane” means viewing a target portion from the top, and the phrase “on a cross-section” means viewing a cross-section formed by vertically cutting a target portion from the side.

Further, throughout the present disclosure, the word “overlap” means a vertically overlapped state in a cross-sectional view, or an entirely or partially disposed state in the same region in a plan view.

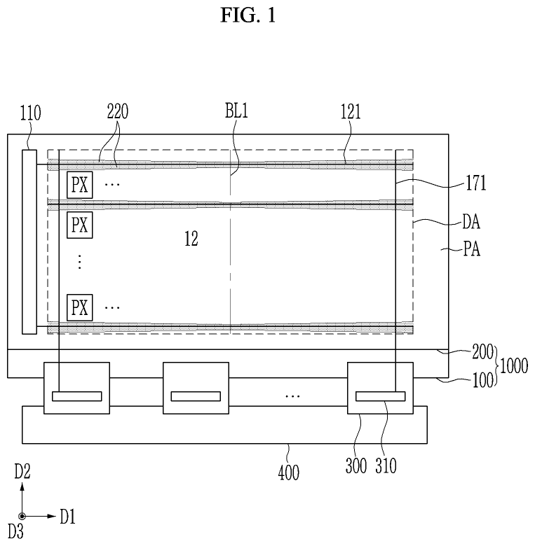

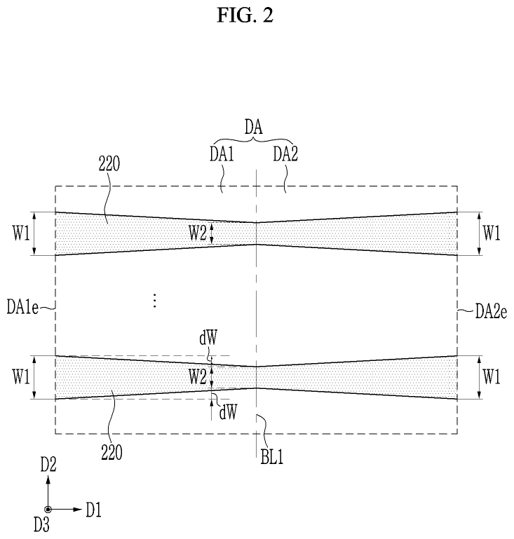

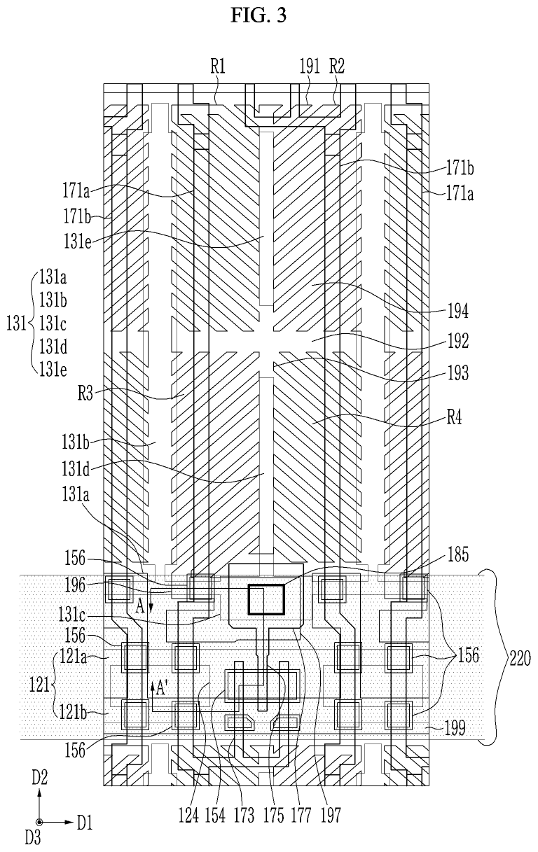

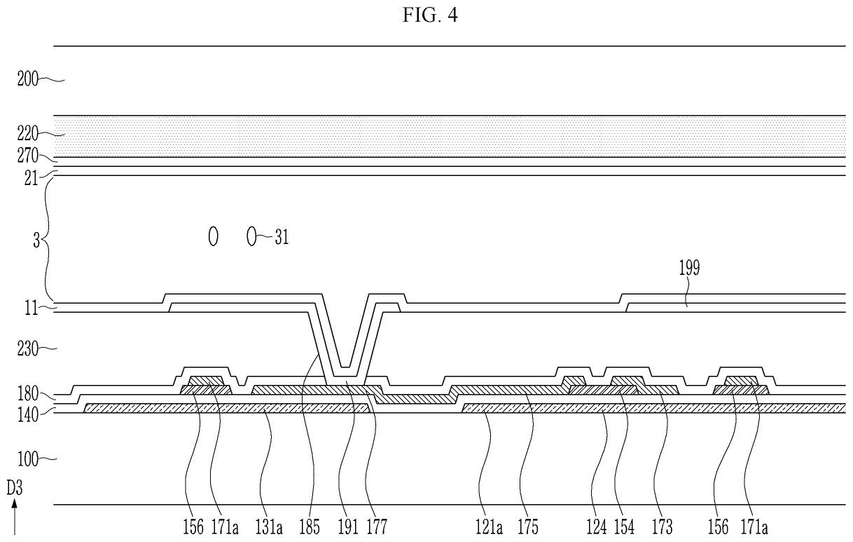

Next, a display device according to an exemplary embodiment of the present disclosure is descried with reference to FIG. 1 to FIG. 4. A planar configuration of a light blocking portion in the display device is described with reference to FIG. 1 and FIG. 2, and a pixel structure of the display device is described with reference to FIG. 3 and FIG. 4.

FIG. 1 is a block diagram schematically showing a display device according to an exemplary embodiment of the present disclosure. FIG. 2 is a top plan view showing a light blocking portion of FIG. 1.

Referring to FIG. 1 and FIG. 2, the display device includes a display panel 1000, a flexible printed circuit board (FPCB) 300, and a printed circuit board (PCB) 400.

The display panel 1000 includes a first substrate 100 and a second substrate 200 overlapping each other. The display panel 1000 includes a display area DA and a peripheral area PA. The peripheral area PA may be a non-display area surrounding the display area DA.

The display area DA may include a plurality of pixel portions PX, and may correspond to a portion of the display panel 1000 in which the first substrate 100 and the second substrate 200 overlap each other. The display area DA includes a plurality of gate lines 121 and a plurality of data lines 171. The plurality of gate lines 121 may extend in a first direction Dl. The plurality of gate lines 121 may be disposed between adjacent ones of the plurality of pixel portions PX. The plurality of data lines 171 may extend in a second direction D2 crossing the first direction D1. In addition to the plurality of gate lines 121 and the plurality of data lines 171, various other signal lines such as a power source line and a storage electrode line may be arranged in the display area DA.

The display area DA includes a plurality of light blocking portions 220 disposed between adjacent ones of the plurality of pixel portions PX and extending in the first direction D1. The light blocking portions 220 may block light between neighboring pixel portions PX. The plurality of light blocking portions 220 may overlap the plurality of gate lines 121. A pixel portion PX may correspond to an area in which a pixel electrode (e.g., the pixel electrode 191 in FIG. 3) is disposed, and through which light is transmitted. The pixel portion PX may be defined by a plurality of light blocking portions 220.

The display area DA may be divided into a first display area DA1 and a second display area DA2 by a first boundary BL1. The first boundary BL1 may extend in the second direction D2 within the display area DA and divide the display area DA into the first display area DA1 and the second display area DA2. In one embodiment, the first boundary BL1 may be disposed at a substantially central portion of the display area DA.

The width of the light blocking portion 220 may decrease from an edge of the display area DA toward the first boundary BL1. The width of the light blocking portion 220 may be measured by the length of the light blocking portion in the second direction D2. The width of the light blocking portion 220 may be the largest at the edge of the display area DA and the smallest at or near the first boundary BL1.

As illustrated in FIG. 2, the light blocking portion 220 may have a first width W1 at a first edge DA1e of the first display area DA1 and a second width W2 at the first boundary BL1. In this case, the first width W1 may be the largest width of the light blocking portion 220, and the second width W2 may be the smallest width of the light blocking portion 220 in the first display area DA1. The first width W1 is greater than the second width W2. Similarly, the light blocking portion 220 may have the first width W1 at a second edge DA2e of the second display area DA2. The width of the light blocking portion 220 may be reduced to the same or substantially similar size on both sides DA1e and DA2e from the edge of the display area DA toward the first boundary BL1. In one embodiment, the first width W1 may be approximately 45 μm, and the second width W2 may be approximately 13 μm to 29 μm, and a size dW to which the width of the light blocking portion 220 is reduced on one side may be approximately 8 μm to 16 μm as a half of the difference between the first width W1 and the second width W2. However, the sizes of the first width W1 and the second width W2 of the light blocking portion 220 are not limited to the present example.

A plurality of flexible printed circuit boards 300 may be provided at least on one edge of the display panel 1000. The plurality of flexible printed circuit boards (FPCB) 300 may be electrically connected to the first substrate 100 on one edge of the first substrate 100 without overlapping the second substrate 200. The flexible printed circuit board (FPCB) 300 may be electrically connected on the first substrate 100 by an anisotropic conductive film (ACF) in the peripheral area PA. Each of the plurality of flexible printed circuit boards (FPCB) 300 may include a data driver 310. The data driver 310 may be mounted on the flexible printed circuit board (FPCB) 300 as a chip-on-film (COF) type. The data driver 310 is connected to the plurality of data lines 171 through the flexible printed circuit board 300, and may provide data voltages to the plurality of data lines 171.

A gate driver 110 providing gate signals to the plurality of gate lines 121 may be disposed in the peripheral area PA of the display panel 1000. The gate driver 110 may have an elongated shape in the second direction D2 along one side of the display area DA.

The printed circuit board (PCB) 400 is electrically connected to the flexible printed circuit board (FPCB) 300. The printed circuit board (PCB) 400 may include a signal controller (not shown) that controls the data driver 310 and the gate driver 110. The signal controller may transmit one or more control signals for controlling the data driver 310 and the gate driver 110 through the flexible printed circuit board (FPCB) 300.

FIG. 3 is a top plan view showing one pixel of a display device an exemplary embodiment of the present disclosure. FIG. 4 is a cross-sectional view of a display device taken along a line A-A′ of FIG. 3.

Referring to FIGS. 3 and 4, the first substrate 100 and the second substrate 200 face each other, and a liquid crystal layer 3 is disposed between the first substrate 100 and the second substrate 200.

A gate conductive layer including a gate line 121, a gate electrode 124, and a storage electrode line 131 is disposed on the first substrate 100. The gate conductive layer may include at least one among copper (Cu), aluminum (Al), magnesium (Mg), silver (Ag), gold (Au), platinum (Pt), palladium (Pd), nickel (Ni), neodymium (Nd), iridium (Ir), molybdenum (Mo), tungsten (W), titanium (Ti), chromium (Cr), tantalum (Ta), and any alloy thereof.

The gate line 121 may include a plurality of gate lines 121a and 121b. The gate line 121 may include two gate lines 121a and 121b extending side by side along the first direction D1. The two gate lines 121a and 121b may be connected to each other to surround the gate electrode 124.

The storage electrode line 131 is spaced apart from the gate line 121 and the gate electrode 124 and may transmit a voltage such as a common voltage. The storage electrode line 131 may be formed in the same layer as the gate line 121, and may be formed of the same material as the gate line 121.

The storage electrode line 131 may include a transverse portion 131a, a plurality of longitudinal portions 131b and 131d, and an extended portion 131c. The transverse portion 131a extends in the first direction D1, and the plurality of longitudinal portions 131b and 131d extend in the second direction D2 and are connected to the transverse portion 131a. The extended portion 131c extends from the transverse portion 131a. The plurality of longitudinal portions 131b and 131d may include two longitudinal portions 131b disposed at respective sides of a pixel electrode 191, and one longitudinal portion 131d extending from the extended portion 131c in the second direction D2. The storage electrode line 131 may further include a floating storage electrode 131e that is spaced apart from one longitudinal portion 131d in the second direction D2.

The storage electrode line 131 is spaced apart from the gate line 121 and may overlap an edge of the pixel electrode 191.

A gate insulating layer 140 is disposed on the gate conductive layer. The gate insulating layer 140 may include an inorganic insulating material such as silicon nitride (SiNₓ), silicon oxynitride (SiON), or silicon oxide (SiOₓ).

A semiconductor layer including a channel semiconductor 154 and a plurality of step-blocking semiconductors 156 is disposed on the gate insulating layer 140. The semiconductor layer may include amorphous or polycrystalline silicon or an oxide semiconductor material. The channel semiconductor 154 may overlap the gate electrode 124.

A data conductive layer including a data line 171, a source electrode 173, and a drain electrode 175 is disposed on the gate insulating layer 140 and the semiconductor layer. The data conductive layer may include at least one among copper (Cu), aluminum (Al), magnesium (Mg), silver (Ag), gold (Au), platinum (Pt), palladium (Pd), nickel (Ni), neodymium (Nd), iridium (Ir), molybdenum (Mo), tungsten (W), titanium (Ti), chromium (Cr), tantalum (Ta), and any alloy thereof.

The data line 171 includes a first data line 171a and a second data line 171b that extend in the second direction D2 to intersect the gate line 121. The first data line 171a is connected to the source electrode 173. Also, the second data line 171b may also be connected to the source electrode 173. The first data line 171a and the second data line 171b may overlap the pixel electrode 191.

The source electrode 173 may have a U-shape extending toward the gate electrode 124 after extending in the first direction D1 from the data line 171. However, the shape of the source electrode 173 is not limited to the U-shape, and it is understood that the source electrode 173 may have various other shapes without deviating from the scope of the present disclosure.

The plurality of step-blocking semiconductors 156 is disposed between the portions where the gate conductive layer and the data line 171 intersect each other to prevent the data line 171 from being disconnected due to a step caused by the gate conductive layer.

The drain electrode 175 is separated from the data line 171 and the source electrode 173. The drain electrode 175 may include a portion facing the source electrode 173 and an extension 177 disposed in an area overlapping the gate electrode 124. Most of the regions between the drain electrode 175 and the source electrode 173 facing each other may overlap the channel semiconductor 154.

The extension 177 may overlap the extended portion 131c of the storage electrode line 131. The extension 177 may overlap the extended portion 131c of the storage electrode line 131 via the gate insulating layer 140 therebetween to form a storage capacitor. The storage capacitor serves to maintain the data voltage applied from the data lines 171a and 171b to the drain electrode 175 and the pixel electrode 191 connected thereto during a display period.

The gate electrode 124, the source electrode 173, and the drain electrode 175 may form a switching transistor along with the channel semiconductor 154. The channel of the switching transistor is formed in the channel semiconductor 154 between the source electrode 173 and the drain electrode 175.

A passivation layer 180 is disposed on the data conductive layer and the semiconductor layer. The passivation layer 180 may include an inorganic insulating material such as silicon nitride (SiNₓ) or silicon oxide (SiOₓ).

A color filter 230 may be disposed on the passivation layer 180. The color filter 230 may include an inorganic insulating material or an organic insulating material. The color filter 230 may uniquely display one of primary colors.

The passivation layer 180 and the color filter 230 may include a contact opening 185. The contact opening 185 may be disposed on the extension 177 of the drain electrode 175, and the drain electrode 175 and the pixel electrode 191 may be connected through the contact opening 185.

A pixel electrode layer including the pixel electrode 191 and a shielding electrode 199 may be disposed on the passivation layer 180 and the color filter 230. The pixel electrode layer may include a transparent conductive material such as indium tin oxide (ITO) and indium zinc oxide (IZO), or at least one of aluminum (Al), silver (Ag), chromium (Cr), and any alloy thereof.

In one embodiment, the pixel electrode 191 may have a generally square shape. The pixel electrode 191 may include a pattern from which one or more portions are removed. For example, the pixel electrode 191 includes a transverse stem portion 192, a longitudinal stem portion 193, a plurality of fine branch portions 194, a connection portion 196, and an extended portion 197.

The transverse stem portion 192 extends substantially in the first direction D1. The longitudinal stem portion 193 may be connected to the transverse stem portion 192 with a crossed shape and extend substantially in the second direction D2.

The pixel electrode 191 may be divided into four sub-regions R1, R2, R3, and R4 by the transverse stem portion 192 and the longitudinal stem portion 193. The plurality of fine branch portions 194 are positioned in the four sub-regions R1, R2, R3, and R4. Each of the plurality of fine branch portions 194 extends diagonally to the first direction D1 and the second direction D2 from one of the transverse stem portion 192 and the longitudinal stem portion 193. The fine branch portions 194 disposed in two of the sub-regions R1 and R2, and R3 and R4, facing via the longitudinal stem portion 193 therebetween, may extend in different directions. The portions that are removed between the neighboring fine branch portions 194 are referred to as fine slits or just slits.

An acute angle formed by the fine branch portions 194 with either the transverse stem portion 192 or the longitudinal stem portion 193 may be about 40° to about 45°, but is not limited thereto. In one embodiment, the acute angle may be adjusted based on the display characteristics such as visibility of the liquid crystal display.

The connection portion 196 may be connected to the fine branch portion 194 of the sub-region R3. The extended portion 197 is connected to the fine branch portion 194 of the sub-region R3 through the connection portion 196, and may overlap the extension 177 of the drain electrode 175.

The extended portion 197 of the pixel electrode 191 is electrically connected to the drain electrode 175 through the contact opening 185, thereby receiving the data voltage.

The ends of the left/right edges of the pixel electrode 191 may overlap the longitudinal portion 131b of the storage electrode line 131. According to another exemplary embodiment, the left/right edges of the pixel electrode 191 may not overlap the longitudinal portion 131b of the storage electrode line 131.

The shielding electrode 199 may be spaced apart from the pixel electrode 191 substantially extending in the first direction D1 and may be disposed in an area overlapping some of the plurality of gate lines 121a and 121b. The shielding electrode 199 may overlap the gate line 121 and extend in the second direction D2 to overlap at least a part of the second data line 171b.

The shielding electrode 199 may be applied with the same voltage as a common electrode 270. In this case, no electric field may be generated between the shielding electrode 199 and the common electrode 270, and liquid crystal molecules 31 disposed between them are not arranged. The liquid crystal molecules 31 between the shielding electrode 199 and the common electrode 270 may be black to serve to block light.

The light blocking portion 220 may be disposed under the second substrate 200. The light blocking portion 220 may prevent light leakage between the neighboring pixel electrodes 191. Particularly, the light blocking portion 220 may be mainly disposed in a region between adjacent pixel electrodes 191. The light blocking portion 220 may be disposed on the second substrate 200 to overlap the gate line 121 and the switching transistor that are disposed on the first substrate 100. The light blocking portion 220 may define an opening region through which light is transmitted, and the opening region through which light is transmitted may be defined as the pixel portion PX.

The common electrode 270 is disposed under the second substrate 200 and the light blocking portion 220. The common electrode 270 may be continuously formed in the display area DA. Similar to the pixel electrode layer, the common electrode 270 may also include a transparent conductive materials such as ITO and IZO, or metals such as aluminum (Al), silver (Ag), chromium (Cr), and any alloy thereof. In one embodiment, the common electrode 270 may not be patterned to include any slit, etc., but may include a slit or a cutout formed in a part thereof in some embodiments.

The color filter 230 previously described as being disposed on the first substrate 100 may be disposed between the second substrate 200 and the common electrode 270.

The liquid crystal layer 3 is disposed between the first substrate 100 and the second substrate 200.

The liquid crystal layer 3 may include liquid crystal molecules 31 having negative dielectric anisotropy. In the absence of an electric field in the liquid crystal layer 3, the long axes of the liquid crystal molecules 31 may be aligned vertically at a predetermined angle with respect to the surfaces of the first substrate 100 and the second substrate 200. The liquid crystal molecules 31 may be pre-tilted depending on a fringe field or a step between edges of the patterned part (e.g., the fine branch portion 194) of the pixel electrode 191 and the common electrode 270.

A first alignment layer 11 may be disposed in the first substrate 100 to cover the pixel electrode 191 and the color filter 230, and a second alignment layer 21 may be disposed under the common electrode 270 in the second substrate 200. The first and second alignment layers 11 and 21 may be vertical alignment layers. A plurality of polymer protrusions formed by reacting a reactive monomer (RM) with light such as ultraviolet rays may be positioned at the surfaces of the alignment layers 11 and 21 adjacent to the liquid crystal layer 3, and these polymer protrusions may maintain the pretilt of the liquid crystal molecules 31 of the liquid crystal layer 3.

The data voltage applied to the pixel electrode 191 determines the arrangement direction (or orientation) of the liquid crystal molecules 31 of the liquid crystal layer 3 disposed between the pixel electrode 191 and the common electrode 270 by generating an electric field between the pixel electrode 191 and the common electrode 270. The luminance of light passing through the liquid crystal layer 3 is controlled according to the determined direction (or orientation) of the liquid crystal molecules 31.

In the example described above, the plurality of gate lines 121 and the pixel electrode 191 are disposed in the first substrate 100, while the plurality of light blocking portions 220 are disposed in the second substrate 200. When the first substrate 100 and the second substrate 200 are bonded to each other at the edge by applying an external pressure to the display panel 1000, the arrangement of the light blocking portion 220 with respect to the pixel electrode 191 may be displaced or dislocated near the center of the display area DA. Hereinafter, the terms “displace” and “dislocate” may be used interchangeably bearing the substantially similar meaning.

When the arrangement of the light blocking portion 220 with respect to the pixel electrode 191 is dislocated, the light blocking portion 220 may cover a portion of the pixel electrode 191, and the luminance may be reduced, and/or a stain may occur. However, as the light blocking portion 220 according to the exemplary embodiment of the present application has a decreasing width from the edge of the display area DA toward the first boundary BL1, even when dislocation of the light blocking portion 220 with respect to the pixel electrode 191 may occur, the staining may be prevented by not covering the pixel electrode 191 with the light blocking portion 220.

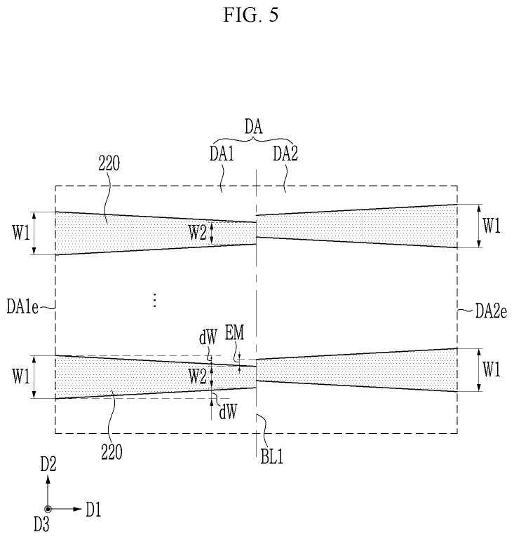

Hereinafter, the light blocking portion 220 serving to prevent an occurrence of stains according to an exemplary embodiment of the present disclosure is described in detail with reference to FIG. 5 to FIG. 7.

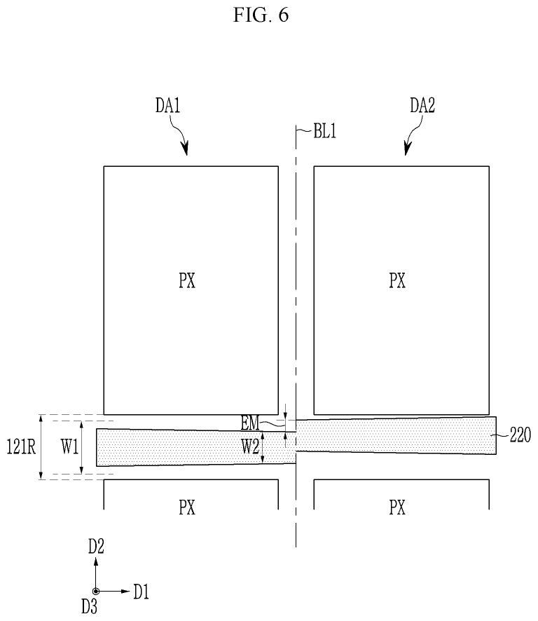

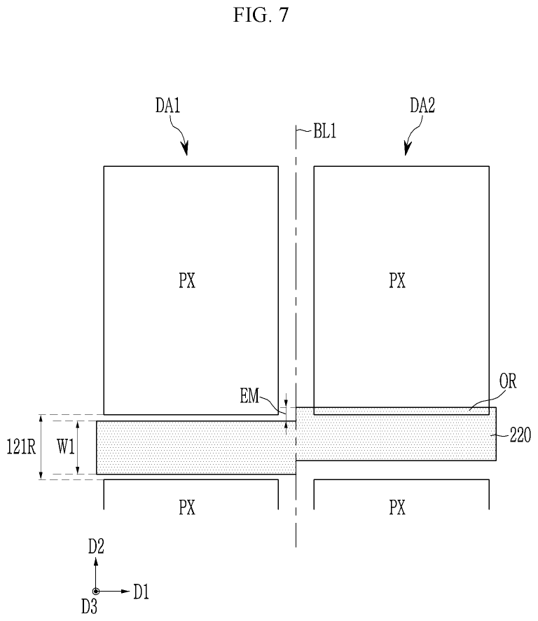

FIG. 5 is a top plan view of a case in which a light blocking portion of FIG. 2 is dislocated by an error margin at a first boundary. FIG. 6 is a top plan view showing a light blocking portion according to an exemplary embodiment of the present disclosure., in which the light blocking portion does not overlap a pixel portion adjacent to a first boundary when a light blocking portion is dislocated by an error margin at the first boundary. FIG. 7 is a top plan view showing a light blocking portion according to a comparative example, in which the light blocking portion overlaps a pixel portion adjacent to a first boundary when a light blocking portion is dislocated by an error margin on a first boundary.

Referring to FIG. 5, in the manufacturing process of the display panel 1000, a first exposure process using a mask initially forms a part of the light blocking portion 220 in the first display area DA1, and a second exposure process using the mask forms other parts of the light blocking portion 220 in the second display area DA2. That is, a part of the light blocking portion 220 in the first display area DA1 may be formed by the first exposure process, and the other part of the light blocking portion 220 in the second display area DA2 may be formed by the second exposure process.

The light blocking portion 220 formed in the first display area DA1 and the light blocking portion 220 formed in the second display area DA2 may not be formed as precisely as illustrated in FIG. 2, but may be formed to be dislocated from each other as illustrated in FIG. 5 due to a process error. For example, the light blocking portion 220 may be dislocated below an error margin EM at the first boundary BL1 due to the process error. The error margin EM may be equal to or smaller than the size dW in which the width of the light blocking portion 220 is reduced on one side. That is, the error margin EM may be equal to or less than half of the difference between the first width W1 and the second width W2 of the light blocking portion 220.

Referring to FIG. 6, the first width W1 of the light blocking portion 220 may be equal to or smaller than a width 121R of the gate line 121 between the pixel portions PX that are adjacent to each other in the second direction D2. FIG. 6 shows a case in which the first width W1 of the light blocking portion 220 is smaller than the width 121R of the gate line 121. The width 121R of the gate line 121 denotes the length in the second direction D2 of the gate line 121 as described above with reference to FIG. 3. The gate line 121 and the gate electrode 124 described with reference to FIG. 3 may be included in the region corresponding to the width 121R of the gate line 121. Because the light blocking portion 220 has the second width W2 at the first boundary BL1, even if the light blocking portion 220 is dislocated by as much as the error margin EM at the first boundary BL1, the light blocking portion 220 does not overlap with the pixel portion PX. Aperture ratios of the pixel portions PX adjacent to the left side of the first boundary BL1 and the pixel portions PX adjacent to the right side of the first boundary BL1 may be the same.

FIG. 7 illustrates a comparative example in which the light blocking portion 220 is formed from the edge of the display area DA to the first boundary BL1 with the first width W1. In the example shown in FIG. 7, the first width W1 of the light blocking portion 220 is smaller than the width 121R of the gate line 121 between the pixel portions PX, but when the light blocking portion 220 is dislocated by the error margin EM in the first boundary BL1 due to a process error, the light blocking portion 220 may overlap with a portion of the pixel portion PX.

When the pixel portions PX adjacent to the right side of the first boundary BL1 overlap the light blocking portion 220 by as much as an overlapping region OR, the aperture ratio of the pixel portions PX adjacent to the right side of the first boundary BL1 may be reduced by the overlapping region OR. In this case, the luminance of the second display area DA2 may be lower than that of the first display area DA1 and vertical line unevenness may be recognized at or near the first boundary BL1.

The light blocking portion 220 may not be dislocated as much so as to overlap the pixel portions PX adjacent to the right side of the first boundary BL1 as illustrated in FIG. 7, and may be formed close to the pixel portion PX. Even in this case, an external pressure applied to the display panel 1000 may displace the arrangement of the light blocking portion 220 so that the light blocking portion 220 may overlap with a portion of the pixel portion PX, and a vertical line stain may be recognized.

However, according to the present embodiment explained with respect to FIGS. 5 and 6, the light blocking portion 220 has the second width W2 at or near the first boundary BL1, and as the error margin EM of the light blocking portion 220 is equal to or smaller than dW, the pixel portion PX is not covered by the light blocking portion 220 at or near the first boundary BL1 preventing the occurrence of the vertical line stain due to the light blocking portion 220.

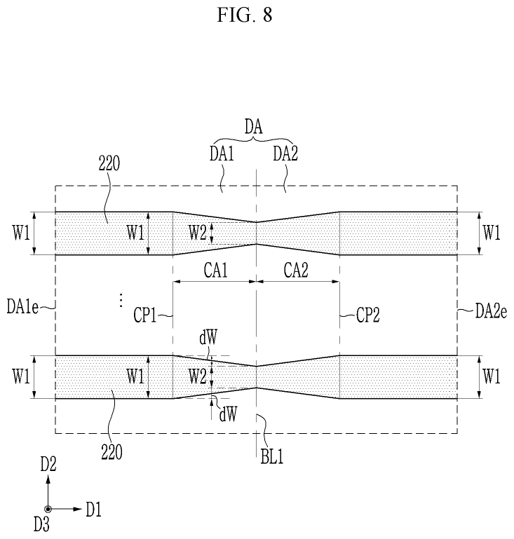

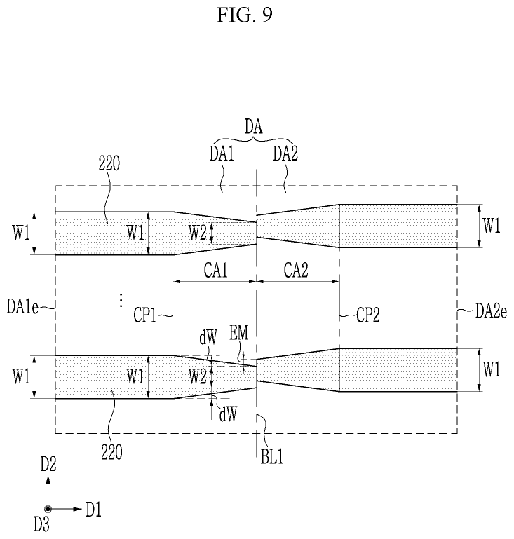

Hereinafter, FIG. 8 and FIG. 9 describe an exemplary embodiment in which the light blocking portion 220 described above with reference to FIG. 2 and FIG. 5 is partially changed. The explanation focuses on the differences compared to the embodiments described with reference to FIG. 2 and FIG. 5.

FIG. 8 is a top plan view showing a light blocking portion according to another exemplary embodiment of the present disclosure. FIG. 9 is a top plan view showing a case in which a light blocking portion of FIG. 8 is dislocated by an error margin at a first boundary.

Referring to FIG. 8, the width of the light blocking portion 220 may be uniform from the first edge DA1e to a first changing portion CP1 in the first display area DA1. That is, the light blocking portion 220 may have the first width W1 from the first edge DA1e to the first changing portion CP1 in the first display area DA1. The width of the light blocking portion 220 may gradually decrease from the first changing portion CP1 toward the first boundary BL1 in the first display area DA1. For example, the light blocking portion 220 may have the first width W1 at the first changing portion CP1 and may have the second width W2 at the first boundary BL1.

Similarly, in the second display area DA2, the width of the light blocking portion 220 may be uniform from the second edge DA2e to a second changing portion CP2. That is, the light blocking portion 220 may have the first width W1 from the second edge DA2e to the second changing portion CP2 in the second display area DA2. The width of the light blocking portion 220 may gradually decrease from the second changing portion CP2 toward the first boundary BL1. For example, the light blocking portion 220 may have the first width W1 at the second changing portion CP2 and may have the second width W2 at the first boundary BL1.

The first changing portion CP1 is disposed in the first display area DA1 between the first edge DA1e and the first boundary BL1, and the second changing portion CP2 is disposed in the second display area DA2 between the second edge DA2e and the first boundary BL1. Each of the first distance CA1 between the first changing portion CP1 and the first boundary BL1 and the second distance CA2 between the second changing portion CP2 and the first boundary BL1 may have a predetermined length. For example, the first distance CA1 and the second distance CA2 may be 3 cm to 6 cm, respectively. However, the first distance CA1 and the second distance CA2 are not limited thereto. In some embodiments, the first distance CA1 and the second distance CA2 may be the same or different from each other in a range from 3 cm to 6 cm.

Referring to FIG. 9, the light blocking portion 220 may be dislocated by less than the error margin EM at the first boundary BL1. Even in this case, the pixel portion PX may not be covered by the light blocking portion 220 in the vicinity of the first boundary BL1, and the vertical line unevenness that may be caused by the dislocation of the light blocking portion 220 may be prevented.

In addition to these differences, the features of an exemplary embodiment described with reference to FIG. 2 and FIG. 5 may be applied to the exemplary embodiments of FIG. 8 and FIG. 9 without deviating from the scope of the present disclosure, and overlapping descriptions between these exemplary embodiments are omitted.

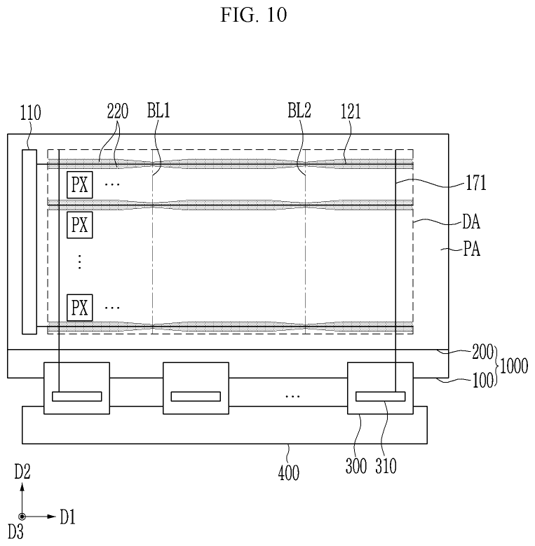

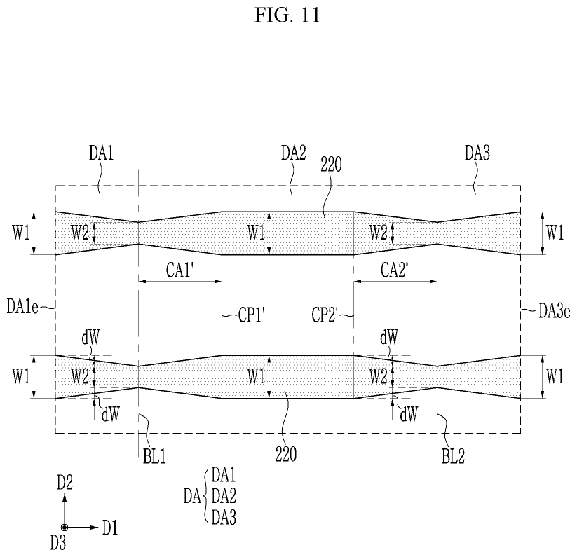

Hereinafter, the display device and the light blocking portion according to another exemplary embodiment are described with reference to FIGS. 10 and 11. The differences compared with the above-described embodiments with respect to FIG. 1 to FIG. 9 are to be mainly described.

FIG. 10 is a block diagram schematically showing a display device according to another exemplary embodiment of the present disclosure. FIG. 11 is a top plan view showing a light blocking portion of FIG. 10 in more detail.

Referring to FIGS. 10 and 11, the display area DA may be divided into the first display area DA1 and the second display area DA2 by the first boundary BL1, and may be further divided into the second display area DA2 and a third display area DA3 by a second boundary BL2. The first boundary BL1 may be disposed at a left part in the display area DA and the second boundary BL2 may be disposed at a right part of the display area DA. That is, the display area DA may be divided into three sub-areas by the first boundary BL1 and the second boundary BL2. The third display area DA3 may correspond to an area where another part of the light blocking portion 220 is formed by a different exposure process (e.g., a third exposure process) in addition to the first and second exposure processes that formed the first display area DA1 and the second display area DA2 of the display panel 1000.

The width of the light blocking portion 220 may decrease from the edge of the display area DA toward the first boundary BL1 or the second boundary BL2. That is, the width of the light blocking portion 220 may decrease from the first edge DA1e toward the first boundary BL1 in the first display area DA1, and the width of the light blocking portion 220 may decrease from a third edge DA3e toward the second boundary BL2 in the third display area DA3. That is, the light blocking portion 220 may have the first width W1 in the first edge DA1e and the third edge DA3e. The light blocking portion 220 may have the second width W2 at the first boundary BL1 and the second boundary BL2.

The width of the light blocking portion 220 may be uniform in the center part of the second display area DA2 between the first changing portion CP1′ and the second changing portion CP2′, may decrease from the first changing portion CP1′ toward the first boundary BL1 and may decrease from the second changing portion CP2′ toward the second boundary BL2.

Each of the first distance CA1′ between the first changing portion CP1′ and the first boundary BL1 and the second distance CA2′ between the second changing portion CP2′ and the second boundary BL2 may have a predetermined length. For example, the first distance CA1′ and the second distance CA2′ may be 3 cm to 6 cm, respectively. However, the first distance CA1′ and the second distance CA2′ are not limited thereto. In some embodiments, the first distance CAI and the second distance CA2′ may be the same or different from each other within a range from 3 cm to 6 cm. An average of the width of the light blocking portion at the second display area may be different from an average of the width of the light blocking portion at the first display area and the third display area.

In addition to these differences, the features of an exemplary embodiment described with reference to FIG. 1 to FIG. 9 may be applied to the exemplary embodiments of FIG. 10 and FIG. 11 without deviating from the scope of the present disclosure, and overlapping descriptions between exemplary embodiments are omitted.

The accompanying drawings and the exemplary embodiments are examples of the present disclosure, and are used to describe the present disclosure, but do not limit the scope of the present disclosure. Thus, it will be understood by those of ordinary skill in the art that various modifications and equivalent embodiments may be made without deviating from the sprit and scope of the present disclosure. The scope of the present disclosure may be defined by the following clams.

What is claimed is:

1. A display device comprising:
a display area including a plurality of pixel portions, a plurality of gate lines extending in a first direction, and a plurality of data lines extending in a second direction crossing the first direction, wherein the display area is divided into a first display area and a second display area by a first boundary that extends in the second direction; and
a plurality of light blocking portions extending in the first direction between adjacent ones of the plurality of pixel portions that are arranged in the second direction to overlap the plurality of gate lines and blocking light between the adjacent ones of the plurality of pixel portions,
wherein a width of a light blocking portion among the plurality of light blocking portions decreases from an edge of the display area toward the first boundary.

2. The display device of claim 1, wherein
the light blocking portion has a first width at a first edge of the first display area and a second edge of the second display area and has a second width that is smaller than the first width at the first boundary.

3. The display device of claim 1, wherein
the width of the light blocking portion is largest at the edge of the display area and smallest at the first boundary.

4. The display device of claim 1, wherein
the light blocking portion is dislocated at the first boundary in the second direction by equal to or less than an error margin.

5. The display device of claim 4, wherein
the light blocking portion has a first width at the edge of the display area, and has a second width at the first boundary, and the error margin is equal to or smaller than half of a difference between the first width and the second width.

6. The display device of claim 1, wherein
the width of the light blocking portion is, in the first display area, uniform from the first edge to a first changing portion and decreases from the first changing portion toward the first boundary, and
the width of the light blocking portion is, in the second display area, uniform from the second edge to a second changing portion and decreases from the second changing portion toward the first boundary.

7. The display device of claim 6, wherein
a first distance between the first changing portion and the first boundary is 3 cm to 6 cm, and a second distance between the second changing portion and the first boundary is 3 cm to 6 cm.

8. The display device of claim 6, wherein
the light blocking portion is dislocated at the first boundary in the second direction by equal to or less than an error margin.

9. The display device of claim 1, wherein
the display area is further divided into the second display area and a third display area by a second boundary, and
the width of the light blocking portion decreases from the edge of the display area toward the second boundary.

10. The display device of claim 9, wherein
the width of the light blocking portion is uniform from a center of the second display area to a first changing portion and decreases from the first changing portion toward the first boundary, and
the width of the light blocking portion is uniform from the center of the second display area to a second changing portion and decreases from the second changing portion toward the second boundary.

11. A display device comprising:
a display area including a plurality of pixel portions, a plurality of gate lines extending in a first direction, and a plurality of data lines extending in a second direction crossing the first direction, wherein the display area is divided into a first display area and a second display area by a first boundary that extends in the second direction; and
a plurality of light blocking portions extending in the first direction between adjacent ones of the plurality of pixel portions that are arranged in the second direction to overlap the plurality of gate lines, blocking light between the adjacent ones of the plurality of pixel portions,
wherein the plurality of light blocking portions extend from a first edge of the first display area to a second edge of the second display area crossing the first boundary, and
wherein a width of a light blocking portion among the plurality of light blocking portions is largest at the first edge and the second edge and is smallest at the first boundary.

12. The display device of claim 11, wherein
the width of the light blocking portion decreases from the first edge toward the first boundary in the first display area and decreases from the second edge toward the first boundary in the second display area.

13. The display device of claim 11, wherein
the light blocking portion is dislocated at the first boundary in the second direction by equal to or less than an error margin.

14. The display device of claim 13, wherein
the light blocking portion has a first width at the first edge and the second edge and has a second width at the first boundary, and the error margin is equal to or less than half of a difference between the first width and the second width.

15. The display device of claim 11, wherein
the width of the light blocking portion is, in the first display area, uniform from the first edge to a first changing portion and decreases from the first changing portion toward the first boundary, and
the width of the light blocking portion is, in the second display area, uniform from the second edge to a second changing portion and decreases from the second changing portion toward the first boundary.

16. The display device of claim 15, wherein
a first distance between the first changing portion and the first boundary is 3 cm to 6 cm, and a second distance between the second changing portion and the first boundary is 3 cm to 6 cm.

17. The display device of claim 15, wherein
the light blocking portion is dislocated at the first boundary in the second direction by equal to or less than an error margin.

18. The display device of claim 11, wherein
the display area is further divided into the second display area and a third display area by a second boundary, and
the width of the light blocking portion decreases from a third edge of the third display area toward the second boundary.

19. The display device of claim 18, wherein
a second average of the width of the light blocking portion in the second display area is different from a first average of the width of the light blocking portion in the first display area or a third average of the width of the light blocking portion in the third display area.

20. The display device of claim 18, wherein
the width of the light blocking portion is uniform from a center of the second display area to a first changing portion and decreases from the first changing portion toward the first boundary, and
the width of the light blocking portion is uniform from the center of the second display area to a second changing portion and decreases from the second changing portion toward the second boundary.
